(19) United States
(12) Patent Application Publication
(10) Pub. No.: US 2026/0063581 A1
(43) Pub. Date: Mar. 5, 2026

(54) DEFECT DETECTION METHOD USING HEAT

(71) Applicant: Tokyo Electron Limited, Tokyo (JP)

(72) Inventor: Ivan Maleev, Fremont, CA (US)

(21) Appl. No.: 18/825,883

(22) Filed: Sep. 5, 2024

(51) Int. Cl. G01N 25/72; G01N 21/64; G01N 25/18

(52) U.S. Cl. CPC G01N 25/72; G01N 21/6489; G01N 25/18

(57) ABSTRACT

A method for detecting a defect in a bonded wafer includes receiving the bonded wafer on a wafer holder, the bonded wafer including a first structure bonded to a second structure, the first structure including first contacts, the second structure including second contacts, and the first structure bonded to the second structure forming a bonding layer including metal contacts between the first contacts and the second contacts. The method further includes illuminating a portion of the first structure for a first time duration to heat the portion of the first structure to a starting temperature, and detecting, using a light detector, a temperature map of the bonded wafer, the temperature map being detected after a second time duration. And the method further includes determining, based on the temperature map, the defect in the bonding layer of the bonded wafer.

### TECHNICAL FIELD

The present invention relates generally to a system and method for detecting defects in semiconductor devices, and, in particular embodiments, to a system and method for detecting defects in semiconductor devices using thermal inspection.

### BACKGROUND

In the semiconductor industry, advanced packaging techniques such as die-to-wafer (D2W) and wafer-to-wafer (W2W) bonding are useful for developing high-performance, compact electronic devices. These processes are essential in applications like 3D integration and Back-Side Power Distribution Networks (BS-PDN). A difficult aspect of these bonding processes is the alignment and fusion of metal contacts, typically in the form of vias, which serve as conduits for electrical signals and heat dissipation between bonded layers.

Detecting defects in these metal contacts, such as voids or cracks, is imperative to diagnose device functionality and subsequently implement measures to prevent fabrication losses. Traditional wafer inspection methods use deep ultraviolet (DUV) microscopy, short-wavelength infrared (SWIR) microscopy, mid-infrared (MIR) microscopy, scanning acoustic microscopy (SAM), and X-ray microscopy. However, existing inspection technologies have limitations.

### SUMMARY

In accordance with an embodiment of this disclosure, a method for detecting a defect in a bonded wafer includes receiving the bonded wafer on a wafer holder, the bonded wafer including a first structure bonded to a second structure, the first structure including first contacts, the second structure including second contacts, and the first structure bonded to the second structure forming a bonding layer including metal contacts between the first contacts and the second contacts. The method further includes illuminating a portion of the first structure for a first time duration to heat the portion of the first structure to a starting temperature, and detecting, using a light detector, a temperature map of the bonded wafer, the temperature map being detected after a second time duration. And the method further includes determining, based on the temperature map, the defect in the bonding layer of the bonded wafer.

In accordance with another embodiment of this disclosure, a method for detecting a defect in a substrate includes loading the substrate on a wafer holder of a chamber, the substrate including an interface layer, first contacts and second contacts, the first contacts aligned to physically contact the second contacts at the interface layer. The method further includes heating a portion of the substrate, cooling the substrate after the heating for a cooling period, and during the cooling period, imaging the substrate to obtain a heat map of the substrate. And the method further includes determining the defect between the first and the second contacts in the interface layer of the substrate based on comparing the heat map with a design map of the substrate.

And in accordance with yet another embodiment of this disclosure, a system for detecting a defect in a bonded wafer includes a wafer holder disposed in a chamber, a light source and a light detector. And the system further includes a controller coupled to the wafer holder, the chamber, the light source, the light detector, and a memory storing instructions to be executed in the controller. The instructions when executed cause the controller to receive the bonded wafer on the wafer holder, the bonded wafer including a first structure bonded to a second structure, the first structure including first contacts, the second structure including second contacts, and the first structure bonded to the second structure forming a bonding layer including metal contacts between the first contacts and the second contacts. The instructions when executed further cause the controller to illuminate, using the light source, a portion of the first structure for a first time duration to heat the portion of the first structure to a starting temperature, and detect, using the light detector, a temperature map of the bonded wafer, the temperature map being detected after a second time duration. And the instructions when executed further cause the controller to determine, based on the temperature map, the defect in the bonding layer of the bonded wafer.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of a bonded wafer illustrating a method for identifying and detecting defects in the bonded wafer in accordance with an embodiment;

FIG. 2 is a top-sectional view of a bonding layer of a bonded wafer illustrating defects in the bonded wafer which may be detected using methods of identifying and detecting defects in the bonded wafer in accordance with an embodiment;

FIG. 3 is a plot illustrating wafer temperature over time in a bonded wafer for a contact compared to a void in accordance with an embodiment;

FIG. 4 is a cross-sectional view of a bonded wafer illustrating a method for identifying and detecting defects in the bonded wafer in accordance with an embodiment;

FIG. 5 is a cross-sectional view of a bonded wafer illustrating a method for identifying and detecting defects in the bonded wafer in accordance with an embodiment;

FIGS. 6A-6B are schematic diagrams of systems for identifying and detecting defects in a bonded wafer in accordance with an embodiment;

FIG. 7 is a flowchart of a method of identifying and detecting defects in a bonded wafer in accordance with an embodiment; and

FIG. 8 is a flowchart of a method of identifying and detecting defects in a bonded wafer in accordance with an embodiment.

### DETAILED DESCRIPTION OF ILLUSTRATIVE EMBODIMENTS

Die-to-Wafer (D2W) and Wafer-to-Wafer (W2W) bonding processes are part of advanced semiconductor wafer packaging, 3D integration processes, and more generally in semiconductor development and future nodes. One example is Back-Side Power Distribution Networks (BS-PDN) approaches where device signal and power lines are placed on opposite sides of the processing (logic) or memory structures. Conventional bonding processes align and then fuse together wafers to form via metal contacts. It is desirable to avoid defects in those via metal contacts, or at the very least detect them as soon as possible. However, a defect inside a metal contact is difficult to detect using traditional wafer inspection methods.

Traditional wafer inspection methods often fall short when identifying internal defects in metal contacts, particularly when via diameters are 1 μm or less. The difficulty is compounded by the desire for an inspection method that can penetrate both silicon substrates and metal while maintaining sufficient resolution to detect small defects.

Existing inspection technologies have various limitations. Deep ultraviolet (DUV) microscopy cannot penetrate silicon substrates, while short-wavelength infrared (SWIR) and mid-infrared (MIR) microscopy struggle with penetrating through metal. Scanning acoustic microscopy and X-ray microscopy, while capable of penetrating the structures, often lack the necessary resolution and can be prohibitively slow and expensive for high-volume manufacturing environments.

Various embodiments for detecting these defects will be described that are sensitive, accurate, fast, and cost-effective. Embodiments of this application describe methods that are sensitive to void defects and cracks in metal vias and bonding substrates, fast enough for HVM (high-volume-manufacturing), and can provide reasonable COO (cost-of-ownership)/COI (cost-of-inspection).

This disclosure describes methods for identifying and detecting defects using thermal properties of the structures. As a result, the method of this disclosure is non-destructive, and offers similar or improved resolution to enable more accurate determination of defects without damaging the structure being sampled. Additionally, because the sample may be heated rapidly through appropriate techniques, the method of this disclosure is as fast, or quicker than conventional defect detection methods, and is more cost efficient than conventional methods by being non-destructive.

The method of this disclosure rapidly heats a layer of a bonded wafer, and then monitors the changes in temperature of either the same layer or a surrounding layer within the bonded wafer. Due to thermal conductivity differences in regions comprising features of different material than the surrounding regions, the monitoring of heat dissipation throughout the bonded wafer enables the detection of defects. For example, a metal contact conducts heat more rapidly than dielectric materials, and as a result, would dissipate the heat to other regions of the bonded wafer faster than regions only comprising dielectric. Further, a region with a void would behave differently than a region with a well formed metal contact, and consequently, the difference in behavior (or thermal conductivity) may be used to identify a defect in the bonded wafer.

Some embodiments of this disclosure may also use bandgap photoluminescence techniques to enable targeted examination of a selected layer of the bonded wafer. As a result, the photoluminescence photons (emitted through targeted excitation and subsequent stimulated emission from the particular layer) may be analyzed to determine temperature changes within the targeted layer. And as a result, the detection of defects may be enabled with a high spatial resolution. Further, the method may be implemented in either a full exposure over the entire bonded wafer, multiple partial exposures, or through a scanning approach that uses a single-spot illumination and scanning to determine defects in the bonded wafer.

In various embodiments, the entire bonded wafer or the portion of the bonded wafer may be exposed to the heat to simultaneously obtain a local heat pattern or heat map (e.g., temperature map, temperature pattern, temperature distribution map) on the entire bonded wafer or the portion of the bonded wafer (such as a particular layer of the bonded wafer). Alternatively, the bonded wafer may be scanned with a line scan or spot scan to locally heat regions of the bonded wafer. Light energy delivery on the wafer may occur via pulse or continuous illumination.

In other embodiments, a flood approach may be used, where a full field-of-view on a sample may be illuminated and imaged on all pixels of a sensor at a same time. And by implementing a flood approach, a sample may further be allowed to move with respect to the system. For example, the flood approach may illuminate and image a full-field-of-view of the sample, move the sample such that a new region of the sample occupies the full-field-of-view, then illuminate and image the new region of the sample in the full-field-of-view, and repeat until the desired regions of the sample have been imaged.

Once a layer of the bonded wafer is heated, a temperature gradient is created. The rate of dissipation of the heat energy depends on thermal conductivity of neighboring structures. In particular, solid metal (e.g. copper) vias serve as good thermal conductors and rapidly remove heat energy from the heated layer to the surrounding layers, thereby cooling the volume directly above the via. In contrast, if there is no via or if the via is damaged (void defect), then the thermal conductivity and heat transfer rate to the surrounding layers is lower compared to the fully functional via, and the heated layer does not cool down as rapidly. Likewise, if there is a crack in the vias at the bond interface of the bonded wafer, it will result in a dramatic change in heat conductivity, and a hot spot above the defect.

The ability to quickly measure the temperature in the previously heated layer above the void or the crack defect enables the detection of the areas of lower temperatures, which correspond to fully functional vias without defect, and also areas of higher temperatures where vias or the bonded wafer are damaged. Comparing the obtained heat maps with a defect free reference (i.e., a good sample) heat maps can help to identify defective regions.

In addition to D2W (die-to-wafer) and W2W (wafer-to-wafer) bonding, a similar approach may be used for advanced packaging applications and inspection of photomasks, pellicles, reticles, as well as substrates made from glass and other non-silicon materials.

Embodiments provided below describe various methods, apparatuses and systems for identifying and detecting defects in a bonded wafer, and in particular, to methods, apparatuses, and systems that use optical techniques to heat and monitor temperature gradients across the bonded wafer to identify and detect defects. The following description describes the embodiments.

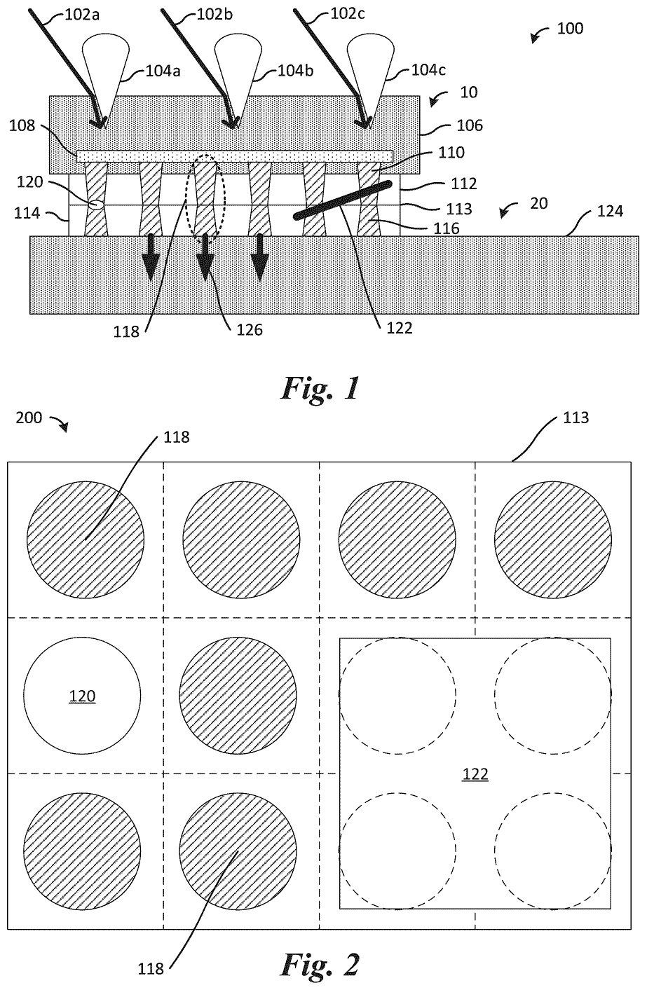

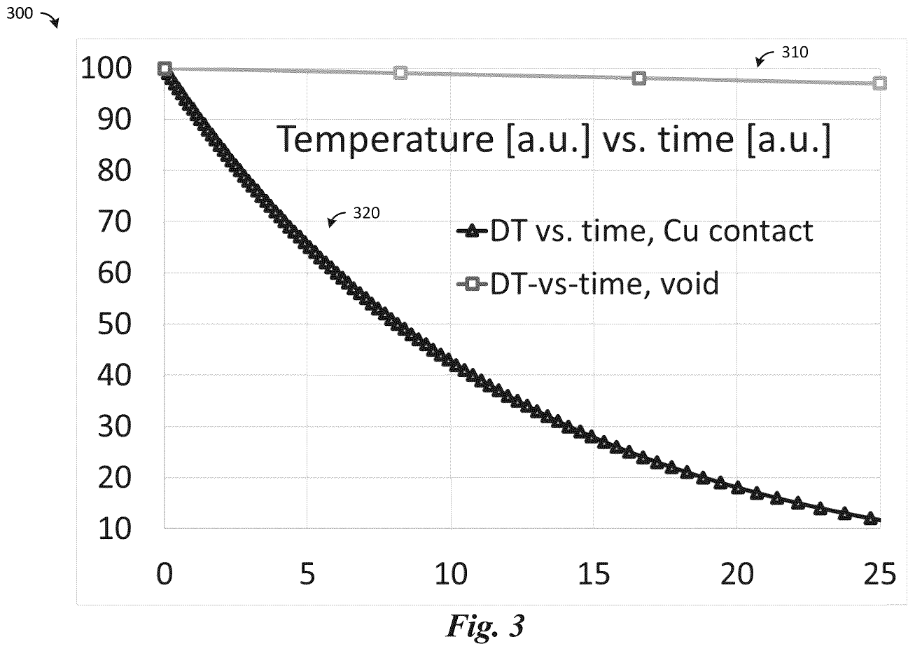

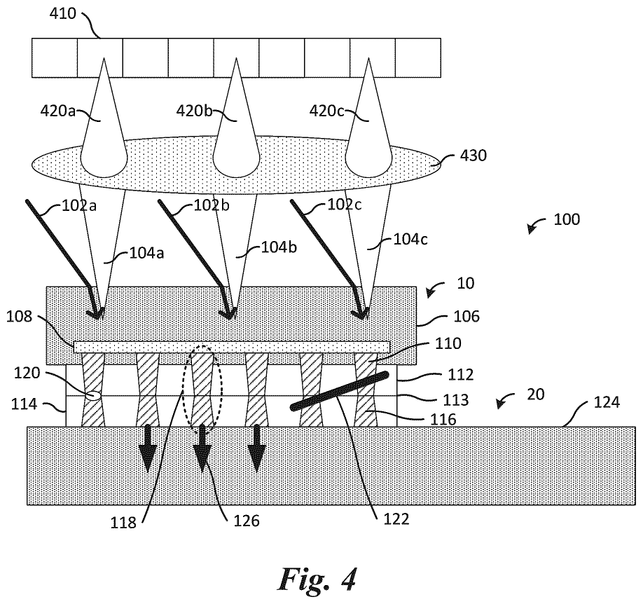

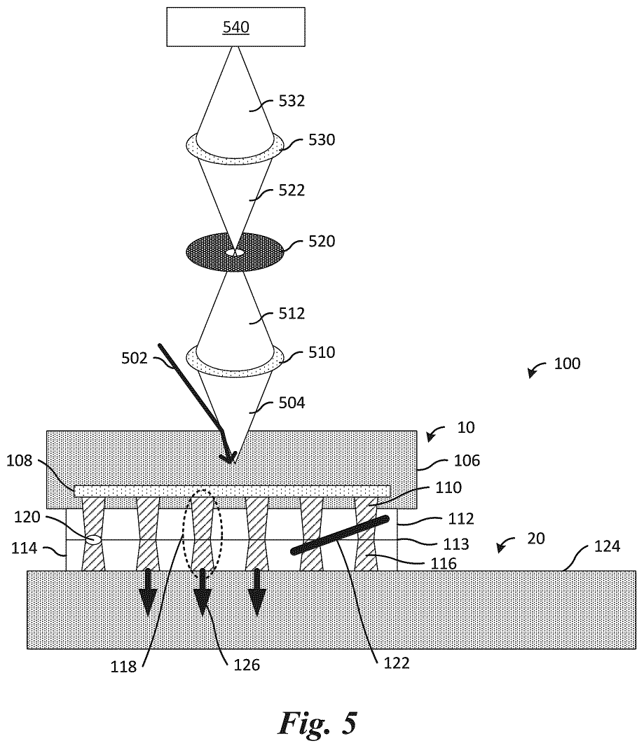

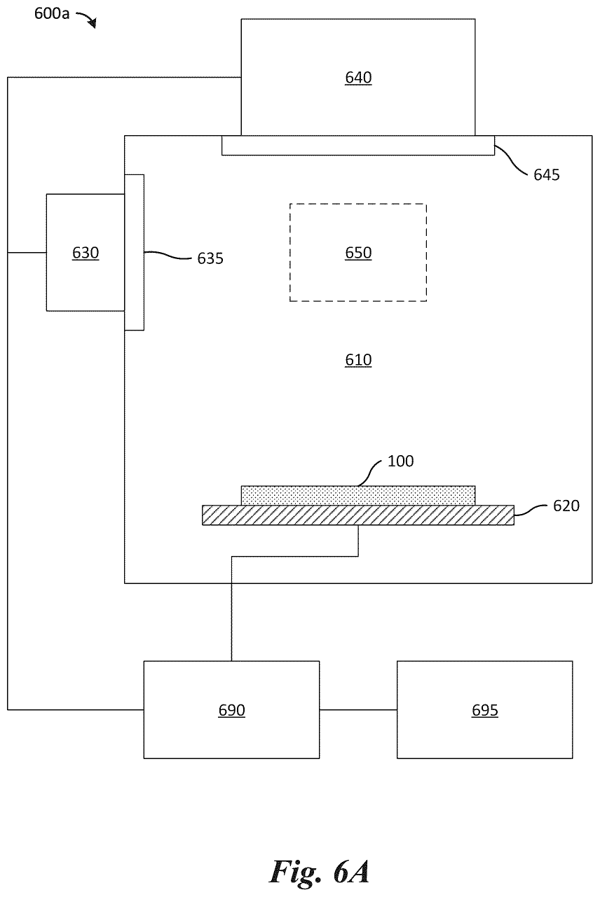

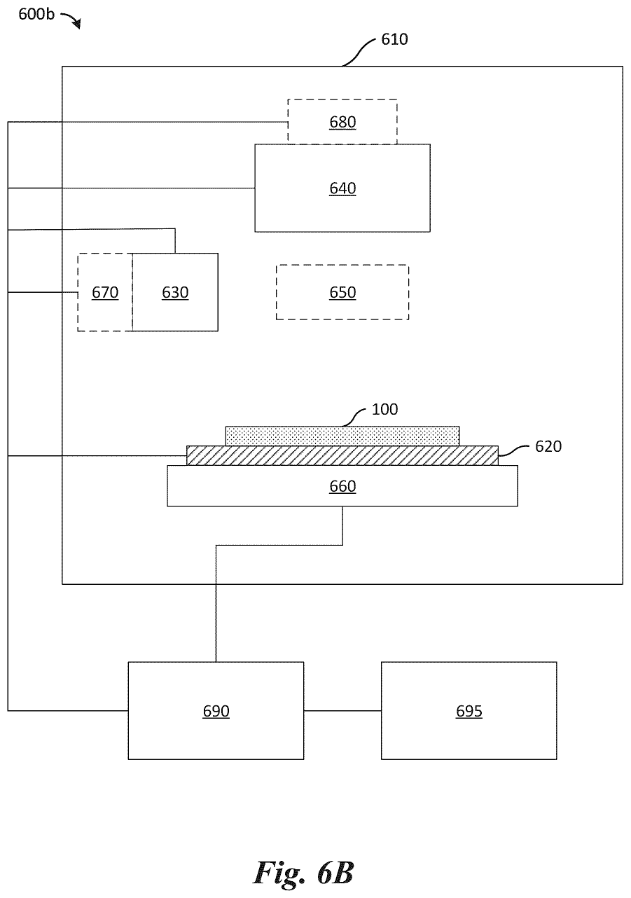

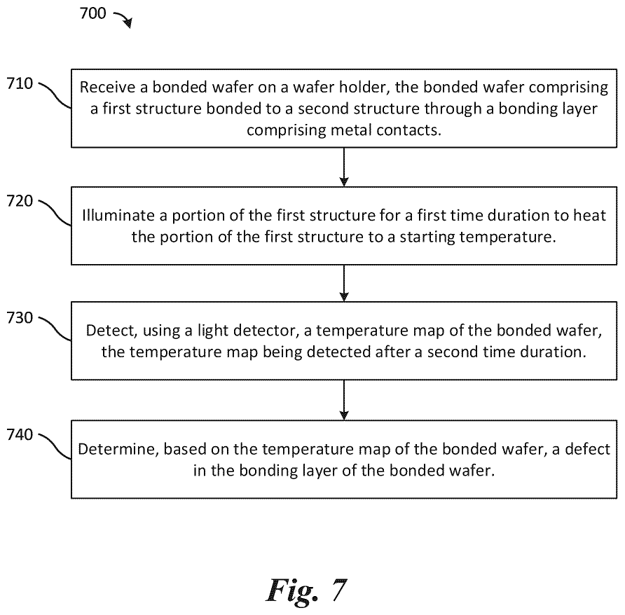

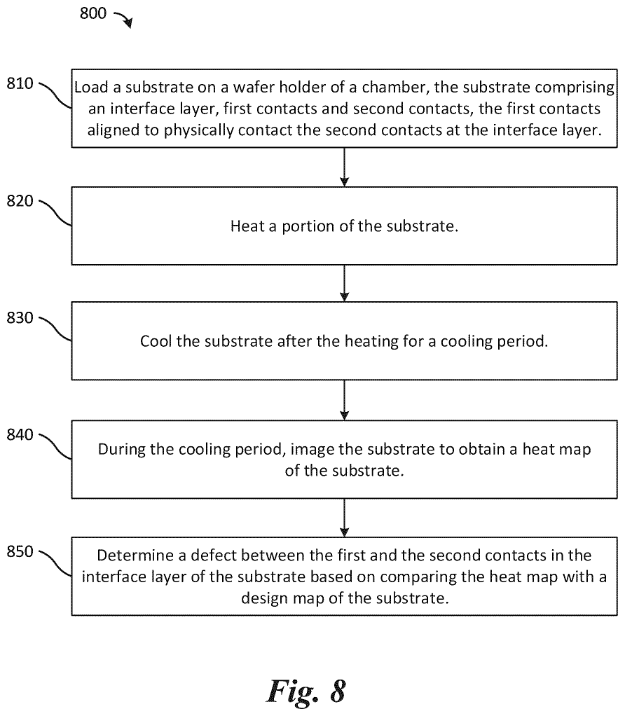

FIG. 1 describes an example method for identifying and detecting defects in a bonded wafer. FIG. 2 describes two example defects detected using embodiment methods of this disclosure. FIG. 3 illustrates difference in temporal temperature changes for a defect and a well formed metal contact. Another embodiment method for detecting defects in a bonded wafer is described using FIG. 4. Yet another embodiment method for detecting defects in a bonded wafer is described using FIG. 5. Two example systems implementing the methods of detecting defects in a bonded wafer are described using FIGS. 6A-6B. And the flowcharts of FIGS. 7-8 illustrate two other example methods of detecting defects in a bonded wafer in accordance with embodiments of this disclosure.

FIG. 1 is a cross-sectional view of a bonded wafer 100 illustrating a method for detecting defects in the bonded wafer 100 in accordance with an embodiment of this disclosure. The bonded wafer 100 as discussed in various embodiments may be formed through any suitable bonding method known in the art, such as direct bonding, hybrid bonding, or fusion bonding.

As illustrated in FIG. 1, the bonded wafer 100 comprises a first structure 10 bonded to a second structure 20. The first structure 10 comprises a first substrate 106 comprising an underlying layer 108 and a first layer 112. The second structure 20 comprises a second substrate 124 comprising a second layer 114. The first structure 10 and the second structure 20 may each comprise a wafer with a plurality of dies formed thereon or a singulated die after processing.

In the embodiment illustrated in FIG. 1, the bonded wafer 100 may be formed by bonding the first layer 112 of the first structure 10 with the second layer 114 of the second structure 20 through a bonding layer 113. The bonding layer 113 may be an interface layer in which the two substrates have bonded, e.g., direct or fusion bonded, in some embodiments.

The first layer 112 comprises first contacts 110 and the second layer 114 comprises second contacts 116. In the embodiment illustrated in FIG. 1, the bonding layer 113 comprises regions where the first layer 112 directly bonds with the second layer 114, and various metal contacts 118 formed through the bonding of the first contacts 110 with the second contacts 116. Additionally, FIG. 1 illustrates potential defects in the bonding layer 113 in the form of a void 120 and a crack 122.

The defects may have formed in the bonding process and may be detected using the methods described in this disclosure. The void 120 may have prevented one of the first contacts 110 from successfully bonding to form a metal contact 118 with a corresponding one of the second contacts 116. The crack 122 may have prevented multiple of the first contacts 110 from successfully bonding to form metal contacts 118 with corresponding second contacts 116. Further, the crack 122 may also have prevented regions of the first layer 112 from directly bonding with corresponding regions of the second layer 114.

Still referring to FIG. 1, the methods of detecting defects in the bonded wafer 100 exposes the first structure 10 with illumination lights 102a-c to heat the first structure 10 to a desired temperature. In various embodiments, the first structure 10 may be exposed to the illumination lights 102a-c for a first time duration, which may be predetermined based on the power of the illumination lights 102a-c to achieve the desired temperature. Ideally, the desired temperature is achieved in the first structure in a short timeframe to avoid thermal conductivity to other elements of the bonded wafer 100.

In the embodiment illustrated in FIG. 1, the illumination lights 102a-c cover the entirety of the first structure 10 to heat the first structure 10 to the desired temperature. Additionally, the illumination lights 102a-c may be beneficially configured based on the material of the first structure 10 to heat the first structure 10 to the desired temperature within the first time duration. For example, in an embodiment where the first substrate 106 is a silicon substrate, the illumination lights 102a-c may comprise wavelengths in the near infrared range (NIR) of about 700 nm to 1000 nm. Other embodiments may utilize different wavelengths for the illumination lights 102a-c based on the materials of the first structure 10.

Heat flow arrows 126 indicate the expected thermal dissipation pathways through the bonded wafer structure. In regions where the metal contacts 118 are intact, heat is efficiently conducted from the first structure 10 to the second structure 20. However, at the locations of the void 120 and the crack 122, the heat flow is impeded, leading to potential temperature variations that can be detected through analysis of the emitted light.

After the first structure 10 reaches the desired temperature, the heat will be conducted throughout the bonded wafer 100 in accordance with the thermal conductivities of proximal elements. For example, the metal contacts 118 may conduct heat better than surrounding regions of directly bonded first layer 112 with second layer 114, and rapidly conduct heat to the second substrate 124 through heat flow arrows 126. As the bonded wafer 100 proceeds towards thermal equilibrium through the flow of heat from the first structure 10 throughout the rest of the bonded wafer 100, a plurality of temperature maps of the first structure 10 may be recorded over a second time duration by collecting emitted lights 104a-c. This emitted light can be attributed to various phenomena, such as photoluminescence, which can provide information about the temperature distribution within the illuminated region. Further, each temperature map of the plurality of temperature maps corresponds to the temperatures of various regions of the first structure 10 at a particular time in the second time duration. Additionally, a temperature map of the bonded wafer 100 may in one implementation be a temperature map corresponding to the first structure 10. And the temperature maps may in some implementations be the distribution of temperatures across the first structure 10 (or other layers or structures of the bonded wafer 100).

Metals in general and copper in particular have very high thermal conductivity compared to dielectrics and even semiconductor materials, such as silicon. For example, copper thermal conductivity can be approximately 400 [W/m K] at room temperature. Thermal conductivity of crystal silicon is approximately 150 [W/m K] and drops rapidly with temperature. In bonding, metallization, and advanced packaging processes, typical materials between metal contacts/vias are dielectrics. For example, 5 nm FINFET metallization processes may use carbon-doped silicon oxide (CDO) in between vias. The thermal conductivity of CDO is approximately 0.4 [W/m K], the thermal conductivity of regular silicon dioxide SiO₂ is approximately 1.3 [W/m K], and the thermal conductivity of SiCN(O) glass can be approximately 1.0 [W/m K]. Hence, in typical use cases (metal contacts in dielectrics), the difference in thermal conductivity between metal and surrounding material can be on the order of 2-3 orders of magnitude. Therefore, in those structures, heat transfer occurs primarily through metal contacts, and the heat transfer rate is much higher through undamaged (no voids or cracks) vias and metal contacts compared to some other materials like semiconductors (silicon) and typical dielectrics (e.g., SiO₂, CDO, or SiCN). In contrast, any defect (such as the void 120 or the crack 122) within the bonding layer 113 may reduce thermal conductivity of the features disposed in that region of the bonded wafer 100 dramatically.

The method of identifying and detecting defects in the bonded wafer 100 may then identify and detect defects in the bonded wafer 100 using the plurality of temperature maps. As an example, localized heated volumes of the first structure disposed above a well formed metal contact 118 may rapidly cool through the heat flow arrows 126 (which may be detected by analyzing the plurality of temperature maps to locate regions of the first structure 10 which rapidly cooled). Further, the cooling of the localized heated volumes indicate good thermal conductivity (the heat is transferred according to expectation). And those particular localized heated volumes with good thermal conductivity may be determined to not have a defect.

In contrast to the localized heated volumes that rapidly cool, localized heated volumes of the first structure 10 which do not cool in accordance with the expected thermal conductivity indicate the presence of a defect in the bonding layer 113. In other words, heat located above a damaged contact does not dissipate nearly as rapidly as heat located above a good metal contact, or a well formed feature. As a result, the determination of the presence of a defect identifies regions of the bonded wafer 100 that does not dissipate heat, or change temperature in accordance with expectation.

The plurality of temperature maps may then be used to distinguish the type of defect present in the localized heated volume that does not cool in accordance with the expected thermal conductivity of that region. For example, in an embodiment where the localized heated volume is located in a single region of the first structure 10 comprising a single first contact 110, the defect corresponds to a void, such as the void 120. As another example, in an embodiment where the localized heated volume that does not cool in accordance with the expected thermal conductivity of that region comprises multiple first contacts 110, the defect corresponds to a crack or a shift between contacts, such as the crack 122. The shift between contacts may be due to overlay error. In other embodiments, a defect spanning multiple first contacts 110 may be a hair-line crack, lateral shift between the first structure 10 and the second structure 20 due to an overlay error, or a localized delamination.

In other embodiments, a starting temperature for the heated layer is preconfigured. As a result, potential defects may be detected by analyzing a single temperature map of the bonded wafer 100 determined after a second time duration. Using the single temperature map, a change in temperature from the known starting temperature may be used to detect defects in the bonded wafer 100. In other embodiments, a heat map may be determined for the heated layer, which may be an image of the heated layer from an infrared (IR) camera (or other suitable imaging devices). In those embodiments, the heat map (or image) may be compared with a reference (or control) heat map (or image) to determine differences corresponding to defects in the heated layer without explicitly calculating temperatures of different regions of the heated layer. In even further embodiments, the heat map may be a temperature map, and may be used as described for the plurality of temperature maps above.

Illumination light 102a, 102b, and 102c is shown incident on the surface of the first structure 10. This illumination can be provided by a suitable light source, such as a laser or LED, with a wavelength chosen to be absorbed primarily within the first substrate 106 or the underlying layer 108, or whichever layer of the bonded wafer 100 is desired to be heated. The illumination lights 102a-c may be used to heat desired layers of the bonded wafer 100 in accordance with embodiment methods for detecting defects in a bonded wafer of this disclosure.

In various embodiments, pulsed illumination lights 102a-c of suitable wavelength with penetration or absorption depth equal to a layer thickness desired to be heated may be used. In particular, the method which uses illumination light intends for the illumination lights 102a-c to be completely absorbed in the targeted layer of the bonded wafer 100 above the vias (except the light reflected from top sample surface). For example, when the bonded wafer 100 is a D2W structure, and where a 50 μm thick silicon die is bonded to the wafer substrate, the illumination lights 102a-c may use visible or near-infrared wavelengths such that the absorption depth for the wavelength is comparable to the die thickness. In this example, the 50 μm thick die silicon substrate may be heated with no energy penetrating into the second structure 20 below, and the heat transfer process through the bonding layer 113 with vias (or first contacts 110 and second contacts 116 forming metal contacts 118) can be facilitated in the most advantageous/efficient way.

The method illustrated in FIG. 1 may use a light detector to collect the emitted light 104a-c to determine the temperature maps of the bonded wafer 100. Additionally, the light detector used depends on the type of emitted light 104a-c employed in the method. In various embodiments, the emitted lights 104a-c may be black body radiation or conventional light emission through thermal radiation, and the light detector may be an infrared camera configured to measure the temperature using the black body radiation. However, in those embodiments, there may be difficulty in localizing the volume that corresponds to the measured temperature.

In other embodiments, a bandgap photoluminescence approach may be used, which may use a light detector to measure photoluminescence photons emanated from the heated layer directly proximal to the bonding layer 113. In those embodiments, a light source (which may be the same light source used to generate the illumination lights 102a-c) may be used to emit an excitation light preconfigured to excite the heated layer proximal the bonding layer 113. The excited heater layer may radiate the emitted lights 104a-c as photoluminescence photons. In bandgap photoluminescence embodiments, the light detector may be a line or area multi-pixel detector.

In alternative embodiments, the localized temperature distribution and resulting stress or thermal expansion may be measured using photoelastic or phase shift deflectometry techniques.

Still referring to FIG. 1, the first structure 10 and the second structure 20 may be any conventional semiconductor structures suitable for forming the bonded wafer 100. For example, the first structure 10 may be a die bonded to the second structure 20 which is a wafer, which may be a carrier wafer or a semiconductor wafer with a plurality of dies formed thereon. In another embodiment, the first structure 10 may be a first semiconductor wafer bonded to the second structure 20 which is a second semiconductor wafer.

The first substrate 106 may be any suitable substrate for which forming the first structure 10 is desired. Specifically, the first substrate 106 may be any suitable substrate for which forming the bonded wafer 100 and using the method of detecting defects in the bonded wafer 100 may be advantageous. In various embodiments, the first substrate 106 is a wafer and is a silicon wafer in one embodiment. In other embodiments, the first substrate 106 is a die and is a silicon die in one embodiment. More possible substrates may be flat panel displays, photolithography masks, and others. Although many substrates are circular, there is no requirement that the first substrate 106 be circular or even substantially circular. For example, the first substrate 106 may be circular, square, rectangular, or any other desired shape such as irregular shapes. The second substrate 124 may be as described above for the first substrate 106, but suitable for forming the second structure 20.

The first layer 112 may be any suitable material for forming the first structure 10. For example, the first layer may be a dielectric layer of SiO₂, or a layer stack comprising alternating dielectric layers of SiO₂ and SiN in various embodiments. Other typical dielectrics which may be used for the first layer 112 comprise CDO or SiCN. Similarly, the second layer 114 may be as described for the first layer 112, and may also be a dielectric layer suitable for forming the second structure 20.

The underlying layer 108 may be any suitable material or comprise electrical devices for which interconnects formed through bonding the first contacts 110 with the second contacts 116 is desired. In other embodiments, the underlying layer 108 may comprise a variety of electrical components formed before depositing the first layer 112 over the underlying layer 108. For example, the underlying layer 108 may be an underlying integrated circuit (IC) formed through conventional methods, and vias which become the first contacts 110 may be formed through conventional methods to form interconnects between the first structure 10 and the second structure 20. In various embodiments, the second structure 20 may also comprise an underlying layer (not shown) which may be as described for the underlying layer 108 of the first structure 10.

The first contacts 110 and the second contacts 116 may be any suitable material for forming the interconnects between the first structure 10 and the second structure 20, and for bonding the first structure 10 and the second structure 20 to form the bonded wafer 100. For example, the first contacts 110 and the second contacts 116 may be metal contacts of copper, tungsten, or any other conventional and/or suitable metal known in the art. Though the contacts are illustrated as interconnects for forming the metal contacts 118 in the figures of this disclosure, the methods of this disclosure may also be used to identify and detect defects in dummy contacts.

The bonding layer 113 may be formed through conventional bonding processes known in the art for forming the bonded wafer 100. As illustrated in FIG. 1, the bonding layer 113 comprises the regions of the first layer 112 and the second layer 114 bonded together, the metal contacts 118 (which facilitate electrical and thermal connections between the first layer 112 and the second layer 114), and any defects which may be present in the bonded wafer 100 (such as the void 120 and the crack 122). The bonded wafer 100 may be bonded by the bonding layer 113 through any conventional bonding process known in the art, such as through adhesive bonding, anodic wafer bonding, eutectic wafer bonding, fusion wafer bonding, glass frit wafer bonding, metal diffusion wafer bonding, hybrid wafer bonding, or solid-liquid inter-diffusion (SLID) wafer bonding.

Though the method illustrated in FIG. 1 uses illumination lights 102a-c to heat the bonded wafer 100, various additional methods of controlling wafer temperature may also be used, such as using a heated or cooled wafer holder for overall wafer temperature control, and localized delivery of hot or cold gases or droplets on a top surface of the bonded wafer 100 (such as cryogenic droplets or molecule clusters).

In various embodiments, the heat applied to the bonded wafer 100 (whether through illumination or any other heating method described above) may be supplied either continuously or in a pulsed mode. Both create temperature gradients in the direction normal to the surface of the bonded wafer 100. However, pulsed modes may enable larger thermal gradients and hence increase sensitivity to potential defects. Additionally, the pulsed mode may minimize lateral heat dissipation.

The method illustrated in FIG. 1 and embodiment methods described throughout this disclosure allow for non-destructive evaluation of the bonded wafer structure, where variations in the intensity or spectral characteristics of the emitted light 104a, 104b, and 104c can be correlated with the presence of defects such as voids 120 or cracks 122 within the bonding layer 113 or the metal contacts 118. Another view of the bonding layer 113 and defects which may be detected in the bonding layer 113 are illustrated in FIG. 2.

FIG. 2 is a schematic top-sectional view of the bonding layer 113 of a bonded wafer 200 illustrating potential defects in the bonded wafer 200 in accordance with an embodiment of this disclosure. Specifically, FIG. 2 provides a complementary perspective to the cross-sectional view shown in FIG. 1. This planar view illustrates the spatial arrangement of features within the bonding layer 113 of the bonded wafer 200 structure.

The figure depicts a regular array of metal contacts 118, represented as circular elements distributed across the surface of the bonded wafer 200. These metal contacts 118 serve as connection points between the upper and lower structures of the bonded wafer, facilitating both electrical connectivity and thermal conductivity.

Interspersed among the regular pattern of metal contacts 118 are two types of defects that can occur in bonded wafer structures. A void 120 is shown as a circular anomaly within one of the metal contacts 118. This void 120 represents a region where the metal contact has not fully formed or has developed a cavity, potentially compromising the electrical and thermal performance of that specific contact point.

Additionally, a crack 122 is illustrated as an irregular line extending across multiple metal contacts 118. This crack 122 represents a structural defect in the bonded layer that can significantly impact the integrity and functionality of the bonded wafer 200. The crack 122 may disrupt multiple metal contacts 118 along its path (illustrated as the dashed circles), potentially causing widespread issues in the affected area. In other embodiments, the crack 122 may be a hairline crack which is a thin crack spreading across multiple metal contacts 118, or a large delamination which may be a region where metal contacts 118 did not properly form and the layers of the bonded wafer 200 are separated.

The regular arrangement of the metal contacts 118 and the clear visualization of the defects (void 120 and crack 122) in this top-down schematic view emphasize the desire for uniform bonding and highlight the challenges in achieving defect-free bonded wafer structures. This perspective is particularly useful for understanding the spatial distribution of defects and their potential impact on the overall performance of the bonded wafer 200. Further, the thermal conductivity in the defect containing regions of the bonded wafer 200 is significantly different than thermal conductivity of the regions comprising well-formed metal contacts 118. As a result, heat flow around the bonded wafer 200 in regions comprising defects is significantly different than regions without defects. An example of the heat dissipation or temperature change rates for a defect containing region compared to a region comprising well-formed metal contacts 118 is illustrated in FIG. 3.

FIG. 3 is a plot 300 illustrating wafer temperature over time in a bonded wafer for a contact compared to a void in accordance with an embodiment of this disclosure. The plot 300 illustrates a first dataset 310 (the squares) graphed along with a second dataset 320 (the triangles) to illustrate the difference in change of temperature over a same timeframe of the first dataset 310 and the second dataset 320. In the embodiment illustrated in the plot 300 of FIG. 3, the first dataset 310 corresponds to temperature over time of a region of a bonded wafer comprising a void, and the second dataset 320 corresponds to temperature over time of a region of a bonded wafer comprising a metal contact (specifically, a copper contact).

As an example, in the plot 300 of FIG. 3, the first dataset 310 may correspond to the temperature change over time that may be determined over the region of the bonded wafer 100 comprising the void 120 of FIG. 1. Similarly, the second dataset 320 may correspond to the temperature change over time that may be determined over the region of the bonded wafer 100 comprising the metal contacts 118 of FIG. 1.

The first dataset 310 depicts the temperature change over time for a region containing a void in the metal contact. This curve shows a relatively slow decrease in temperature following the initial thermal excitation. The gradual cooling represented by this dataset is indicative of reduced thermal conductivity in the region, and is consistent with the presence of a void that impedes efficient heat transfer.

In contrast, the second dataset 320 represents the temperature change over time for a region containing an intact metal contact. This curve exhibits a more rapid decrease in temperature following the initial thermal excitation. The steeper cooling rate illustrated by this dataset reflects the higher thermal conductivity of the intact metal contact, which allows for more efficient dissipation of heat through the bonded wafer structure.

The distinct behaviors of these two datasets, 310 and 320, demonstrate the principle underlying the thermal detection method for identifying voids and other defects in bonded wafer structures. The divergence between the two curves over time provides a clear signal that can be used to differentiate between regions with intact metal contacts and those containing voids or other thermal discontinuities. As a result, the drastic difference in thermal conductivity between a region comprising well-formed metal contacts compared to regions comprising defects may be used to identify and detect defects (by monitoring for rate of temperature change in the bonded wafer), such as described using the method illustrated in FIG. 1.

This graphical representation underscores the time-dependent nature of the thermal response and highlights benefits of monitoring temperature changes over an appropriate duration to effectively detect and characterize defects in bonded wafer structures.

Other embodiments also use the difference in thermal conductivities to identify and detect defects in a bonded wafer, but use bandgap photoluminescence to enable location specific temperature measurements of the bonded wafer. Further, the location specific temperature measurements enable the detection of temperature changes in various regions of the bonded wafer with a higher resolution. An embodiment method for identifying and detecting defects in a bonded wafer using bandgap photoluminescence for the temperature measurements is described using FIGS. 4-5 below. FIG. 4 illustrates an embodiment method on a stationary bonded wafer, and FIG. 5 illustrates an embodiment method which may scan either a detection system or the bonded wafer to identify and detect defects in the bonded wafer.

FIG. 4 is a cross-sectional view of the bonded wafer 100 illustrating a method for identifying and detecting defects in the bonded wafer 100 in accordance with an embodiment of this disclosure. Additionally, FIG. 4 demonstrates a multi-spot illumination and detection scheme, which may be capable of exposing and collecting light over the entire bonded wafer 100 simultaneously. Similarly labeled elements may be as previously described. Specifically, FIG. 4 illustrates an embodiment method which may use bandgap photoluminescence to monitor and measure the temperature of the bonded wafer 100 throughout the method of identifying and detecting defects in the bonded wafer.

Consequently, in FIG. 4, the emitted lights 104a-c are the result of an excitation light being used to cause stimulated emissions of photoluminescence photons through bandgap photoluminescence of specific regions of the bonded wafer 100 targeted by the excitation light. The absorption depth of the excitation light used to cause the emission of photoluminescence photons through bandgap photoluminescence may be controlled through the selection of wavelength used.

As a result, the excitation light may target specific layers of the bonded wafer 100 to cause photoluminescence photons to be emitted exclusively from the targeted regions. As a result, bandgap photoluminescence temperature measurement methods are capable of higher resolution than other methods.

After, the emitted lights 104a-c (photoluminescence photons) may be collimated and directed using imaging optics 430 for collection to determine the plurality of temperature maps of the bonded wafer 100. And the imaging optics 430 may produce focused lights 420a-c from the emitted lights 104a-c, respectively.

As illustrated in FIG. 4, a light detector 410 may be used to collect focused lights 420a-c to determine a plurality of temperatures for each portion of the bonded wafer 100 over a second time duration. In various embodiments, the light detector 410 may be a line multi-pixel detector, or an area multi-pixel detector. The light detector 410 may spatially resolve and register light of a spectrum comprising wavelengths between about 1000 nm and 1200 nm and targeted for the detection of the photoluminescence photons. The imaging optics 430 are designed to efficiently collect the emitted lights 104a-c from the bonded wafer 100 and may comprise a system of lenses, or mirrors, or other suitable conventional optical equipment known in the art.

The light detector 410 is positioned to receive the collected light from the imaging optics 430. This detector may be a high-sensitivity, multi-pixel sensor capable of resolving spatial and spectral information from the emitted light. The detector 410 can capture the intensity and potentially the spectral characteristics of the light emitted, providing data that can be correlated with the local thermal properties of the bonded wafer 100.

This multi-spot configuration allows for simultaneous probing of multiple areas on the bonded wafer 100 surface, enabling efficient spatial mapping of thermal properties. By analyzing the differences in the emitted light characteristics from various spots, it becomes possible to identify and locate defects such as voids or cracks within the bonded structure.

The arrangement shown in FIG. 4 demonstrates a practical implementation of the thermal detection principle, showcasing how optical techniques can be employed for non-destructive evaluation of bonded wafer structures. This approach allows for rapid, high-resolution imaging of wafer surfaces to detect and characterize defects that may impact the performance and reliability of the bonded structures. A scanning, or localized single-spot configuration that also uses bandgap photoluminescence is illustrated in FIG. 5.

FIG. 5 is a cross-sectional view of the bonded wafer 100 illustrating a method for identifying and detecting defects in the bonded wafer 100 in accordance with an embodiment of this disclosure. Similarly labeled elements may be as previously described. Further, FIG. 5 illustrates a refined optical configuration for analyzing the thermal properties of a bonded wafer structure 100, incorporating additional components to enhance the sensitivity and specificity of the measurement system and enable the scanning over the bonded wafer 100 (as opposed to the multi-spot illumination methods described using FIG. 1 and FIG. 4 above).

The system begins with illumination light 502, which is directed onto the surface of the bonded wafer structure 100. This illumination serves to excite the sample and induce thermal changes in the structure over the specific region exposed to the illumination light 502. In an embodiment, the illumination light 502 may have a wavelength of 785 nm. In other embodiments, the illumination light 502 may comprise single wavelengths from or spectrums of wavelengths from the NIR spectrum (between about 700 nm to about 1000 nm). In response to the heating through the illumination light 502, an excitation light comprising wavelengths between about 1000 nm to about 1200 nm may be used to cause bandgap photoluminescence photons to be emitted from the bonded wafer 100 in the corresponding region in the form of emitted light 504, which carries information about the local thermal properties of the illuminated region.

The emitted light 504 is collected and focused by the first relay optics 510, resulting in first focused light 512. This initial focusing step helps to collimate and direct the emitted light for further processing. The first focused light 512 passes through a spatial filter 520, which selectively transmits light from specific layers of interest within the bonded wafer structure. This filtering process produces filtered light 522, which contains information primarily from the desired depth or layer within the sample, such as the region immediately above the bonding layer 113.

The filtered light 522 then encounters second relay optics 530, which further focuses the light into second focused light 532. This additional focusing step helps to optimize the light collection efficiency and spatial resolution of the system. And finally, the second focused light 532 is directed onto a light detector 540. This detector may be a high-sensitivity, single-pixel or multi-pixel sensor capable of measuring the intensity and potentially the spectral characteristics of the incoming light. In various embodiments, the light detector 540 may be a single pixel photodiode, an avalanche photodiode (APD), a photomultiplier tube (PMT), or another single-pixel detector, or multi-pixel detector.

The incorporation of the spatial filter 520 and multiple relay optics (510 and 530) allows for precise control over which regions of the sample contribute to the detected signal. This configuration can significantly enhance the system's ability to isolate information from specific layers or interfaces within the bonded wafer structure, potentially improving the detection sensitivity for defects such as voids or cracks.

By scanning the illumination light 502 across the wafer surface and analyzing the resulting signals at the light detector 540, this system can create a detailed map of thermal properties across the bonded wafer structure. This approach enables non-destructive, high-resolution evaluation of bonded interfaces and can identify localized defects that may impact the performance or reliability of the bonded wafer structure. This approach may be referred to as a spot scan approach and may be beneficial particularly when precise control over depth and thickness of the measured layer is desired or to save cost and complexity vs imaging multi-pixel sensor approach. In comparison to the imaging multi-pixel approaches of FIG. 1 and FIG. 4, the spot scan approach of FIG. 5 may be less time efficient with limited spatial resolution.

Once the map of temperature in the layer above the bonding layer 113 is generated, one may use standard image analysis techniques to map hot locations on the map to various defects in the bonding layer 113. It is noted that the localized heating of the bonding layer 113 and metal contacts 118 in general may result in an annealing effect, potentially fusing and thereby eliminating void and crack defects. Any instances where the annealing effect may occur may be detected by monitoring changes in thermal conductivity behavior in the temperature maps.

In addition to the flood imaging/multi-spot approaches, and scanning/single-spot approaches, as well as the bandgap photoluminescence approaches, other embodiments may use different thermal imaging techniques to form the temperature maps used to detect defects in the bonded wafer. For example, other approaches may use a multi-spot approach with multiple illumination spots created using an acousto-optic deflection (AOD) technique. Likewise, temperature measurement techniques are not limited to the bandgap photoluminescence, but may use mid-infrared thermal imaging camera to register black body radiation, particularly when combined with spatial filtering, as well as other suitable temperature measurement techniques.

The above detailed description focuses on D2W (die-to-wafer) and W2W (wafer-to-wafer) applications. For those applications with e.g. silicon substrates one may use near-infra-red light for heating up the sample, for example in 700 nm to 900 nm range, and then collect photoluminescence light also from near-infrared wavelengths, for example in 1000 to 1200 nm range. However, the systems and methods of this disclosure are not limited to bonded wafers, and in the inspection of photomasks or advanced packaging processes on glasses, the same wavelengths may not be suitable, and there is no semiconductor bandgap photoluminescence effect. In contrast, other embodiments may deliver heat to e.g. glass layers by using e.g. short-wave-infra-red or mid-infra-red wavelengths instead of near-infrared, or by heating highly absorbing metal layers directly. For example, by using a wafer holder capable of heating the sample being imaged for defect detection.

A feature of the method is to select the light of wavelengths that are absorbed in the desired layer of a potential sample (such as a bonded wafer), such as glasses or metals, and then track changes in the temperature of the same or another layer over time using appropriate techniques, not limited to photoluminescence. For example, various embodiments may heat the metal layer with visible light, and then use e.g. black-body radiation detector, such as mid-infra-red camera to measure the temperature of either the metal layer, or another layer, which is thermally connected to the heated layer, and with that thermal connection potentially impacted by voids or crack defects in the sample itself (on/in any thermally connected features such as metal contacts). Systems capable of implementing the defect detection methods described above are illustrated and described using FIGS. 6A-6B below.

Embodiment systems capable of implementing the methods of identifying and detecting defects in a bonded wafer described using FIGS. 1, 4, and 5 are described using FIGS. 6A-6B. FIGS. 6A-6B are schematic diagrams of systems for identifying and detecting defects in a bonded wafer 100 in accordance with an embodiment of this disclosure.

FIG. 6A is a schematic diagram of a system 600a which may be used to implement the methods for identifying and detecting defects in the bonded wafer 100 in accordance with embodiments of this disclosure. System 600a comprises a chamber 610, a light source 630, a light detector 640, a controller 690, and a memory 695.

The system 600a is built around a chamber 610, which provides a controlled atmosphere for the analysis process. This chamber may be capable of maintaining specific environmental conditions such as temperature, pressure, or gas composition to optimize the measurement process. For example, the chamber 610 may be a vacuum chamber, or a bonding chamber where the bonded wafer 100 was originally bonded. Further, in some embodiments where the chamber is a bonding chamber, the methods of this disclosure may perform the method of detecting defects after an annealing process during the bonding. In other embodiments, the chamber 610 may be an integrated metrology module.

Within the chamber 610, a wafer holder 620 is positioned to securely support the bonded wafer 100 under examination. The wafer holder 620 may comprise features for precise positioning and potentially for temperature control of the sample. In various embodiments, the wafer holder may be a conventional wafer holder known in the art, such as an electrostatic chuck, a vacuum chuck, or other forms of chucks that mechanically grip the bonded wafer 100 to hold it in place.

A light source 630 is situated outside the chamber 610, directing illumination through a first window 635 into the chamber to heat the bonded wafer 100 for the methods of this disclosure. This light source 630 provides the excitation energy necessary for inducing thermal changes in the bonded wafer 100. Additionally, in embodiments that use bandgap photoluminescence, the light source 630 may provide the light to cause the stimulated emission of photoluminescence photons.

A light detector 640 is positioned to receive light emitted from the sample through a second window 645. This detector captures the optical signals that carry information about the thermal properties of the bonded wafer 100, which may be used to determine temperature maps of the bonded wafer 100.

Between the second window 645 and the light detector 640, relay optics 650 are arranged to collect, focus, and potentially filter the emitted light. These optics may comprise various elements such as lenses, mirrors, or filters to optimize the signal reaching the detector. For example, in an embodiment, the relay optics 650 comprise a spatial filter to select a specific measurement depth and a specific measurement layer thickness. In various embodiments, the relay optics 650 may comprise the imaging optics 430 of FIG. 4.

In certain embodiments, a spot scanning approach may be used where the light source 630 may illuminate specific spots of the bonded wafer 100, and the light detector 640 may image specific spots of the bonded wafer 100. For example, in certain embodiments, the relay optics 650 may comprise mirrors or lenses that individually move for each of the light source 630 and the light detector 640. As a result, the mirrors or the lenses used in the relay optics 650 may enable the imaging and illuminating of different regions of the bonded wafer 100, or the same region of the bonded wafer 100 simultaneously.

In other embodiments, a flood illumination approach may be enabled to image an entire surface of the bonded wafer 100 after flooding the surface with illumination light to heat the bonded wafer 100, or to image particular regions of the bonded wafer 100 after flooding the surface with illumination light.

The system 600a is managed by a controller 690, which coordinates the operations of various components. This controller may adjust parameters such as illumination intensity, detection sensitivity, or sample positioning to optimize the measurement process. Further, the controller 690 may be electrically coupled to the light source 630, the light detector 640, and the wafer holder 620 to control the system 600a and implement the method for identifying and detecting defects in a bonded wafer of this disclosure.

Connected to the controller 690 is a memory 695, which stores data, measurement parameters, and any potential analysis algorithms used to detect defects in the bonded wafer 100. This memory allows for the recording of measurement results and the implementation of sophisticated data processing techniques.

The first window 635 and the second window 645 may be any material suitable for allowing the illumination light, excitation light, and emitted light to pass through without impeding the light, such as crystalline silicon (c-Si), SiO₂, quartz, glass, Al₂O₃ (sapphire), or other suitable materials. Further, the first window 635 and the second window 645 may be any material that enables NIR, SWIR, or any particular wavelength of light suitable for the methods of this disclosure to pass through unimpeded.

The light detector 640 may be any device known in the art suitable for collecting wavelengths of emitted light from the bonded wafer 100 to measure the temperature. For example, the light detector 640 may be photodiodes, a photomultiplier tube (PMT), charge-coupled devices (CCDs), complementary metal-oxide-semiconductor (CMOS) sensors, phototransistors, or lasers such as a Q-switched laser. Further, the light detector 640 may be a single point or a multi-pixel imaging sensor. In some embodiments, the light detector 640 may be the light detector 410 of FIG. 4, or the light detector 540 of FIG. 5. In some embodiments, the light detector 640 may be an infrared camera or a mid-infrared camera. In other embodiments, the light detector 640 may be a time delay integration (TDI) sensor. In various embodiments, the light detector 640 may be an imaging microscope capable of flood illumination, where the imaging microscope is either a bandgap photoluminescence microscope or a mid-infrared (mid-IR) camera. And in even further embodiments, the light detector 640 may be a spot scanning system configured to implement the spot scan approach.

The light source 630 may be any device known in the art suitable for generating the light used to project the illumination light or excitation light onto the bonded wafer 100 to heat particular layers of the bonded wafer 100 or cause the stimulated emission of photoluminescence photons to be used to measure the temperature of the bonded wafer 100. For example, the light source 630 may be a pulsed or continuous (CW) laser or laser diode, light emitting diode (LED), a broadband light source, a gas discharge flash lamp, or lasers such as a Q-switched laser. In various embodiments, the light source 630 may be capable of producing a spectrum of wavelengths of light (λ) between about 700 nm and about 1200 nm (700 nm≤λ≤1200 nm) to compromise between optical resolution and chamber material transmissive properties.

The light source 630 may be pulsed, or made to emit light over brief timeframes, and then immediately followed by the temperature mapping of the bonded wafer 100 to avoid the heat from the illumination redistributing through the bonded wafer 100 before measuring the temperature map and monitoring rapid changes of temperature. For example, the light source 630 may emit at frequencies (f) between about 100 Hz to about 10 kHz (100 Hz≤f≤10 kHz). And after measuring a plurality of temperature maps for a second time duration, a waiting period may be implemented to allow the heat to redistribute through the entire bonded wafer 100 to reach thermal equilibrium before the light source 630 is pulsed again.

In various embodiments, the light source 630 may be advantageously selected for the optimal heating depending on the type of material of the bonded wafer 100. Various embodiments may use light in the visible spectrum, the ultraviolet spectrum, or the infrared spectrum of wavelengths to illuminate and heat the surface of the bonded wafer 100.

The memory 695 may be any suitable memory device for storing instructions for performing the method of this disclosure to be executed by the controller 690. Further, the memory 695 may be any suitable device capable of storing measurements made by the system 600a (such as an EPD by a light sensing element of the light detector 640). For example, the memory 695 may be a solid state drive (SSD), a hard disk drive (HDD), or some form of volatile memory device such as dynamic random access memory (DRAM).

The controller 690 may be any suitable device capable of executing the method of this disclosure. By controlling the light source 630 to emit light to heat the bonded wafer 100, and by controlling the wafer holder 620 to hold the bonded wafer 100 and collect emitted light using the light detector 640, the controller 690 may implement the method for identifying and detecting defects in a bonded wafer of this disclosure. In various embodiments, the controller 690 may be an application specific integrated circuit (ASIC), a field programmable gate array (FPGA), a microcontroller (MCU), or some form of programmable logic circuit (PLC). The controller 690 in FIG. 6A is capable of implementing the multi-spot approach of illuminating multiple spots over the bonded wafer 100 or the entire bonded wafer 100, and may implement methods for a stationary bonded wafer 100, such as method 700 described using the flowchart of FIG. 7.

The configuration shown in FIG. 6A represents an integrated approach to thermal analysis of bonded wafer structures. By combining controlled environmental conditions, precise optical excitation and detection, and computerized control and analysis, this system enables detailed, non-destructive evaluation of bonded interfaces and can identify defects that may impact the performance or reliability of bonded wafer structures.

FIG. 6B is a schematic diagram of a system 600b which may be used to implement the methods for identifying and detecting defects in the bonded wafer 100 in accordance with embodiments of this disclosure. System 600b comprises the chamber 610, the controller 690, and the memory 695. Similarly labeled elements may be as previously described.

In contrast to the system 600a of FIG. 6A, the light source 630 and the light detector 640 are disposed within the chamber 610 in system 600b of FIG. 6B. Consequently, the system 600b does not use windows to optically couple the light source 630 and the light detector 640 to the chamber 610. The chamber 610 in system 600b comprises the light source 630, the light detector 640, the relay optics 650, the wafer holder 620, and a TZ stage 660. Further, the bonded wafer 100 is disposed on the wafer holder 620 within the chamber 610.

FIG. 6B illustrates an alternative configuration of the thermal analysis system, designated as system 600b. This setup incorporates additional components to enhance the flexibility and enable scanning capabilities for the implementation of single-spot approaches to the method of identifying and detecting defects in a bonded wafer of this disclosure. For example, the system 600b may implement the method illustrated using FIG. 5.

The core of the system 600b remains the chamber 610, which provides a controlled environment for the analysis process. Within this chamber, the wafer holder 620 is positioned to securely support and potentially control the temperature of the bonded wafer 100 under examination. Additionally, the chamber 610 comprises the light detector 640 coupled to a second scanner 680, the light source 630 coupled to a first scanner 670, relay optics 650 (which may be as described for the optics illustrated in FIG. 5), and the wafer holder 620 disposed on a TZ stage 690.

In various embodiments, the first scanner 670 and the second scanner 680 enable the scanning of a single-spot across the bonded wafer 100. The first scanner 670 and second scanner 680 are optional configurations to enable the scanning. In other embodiments, the first scanner 670 and second scanner 680 are not present and the scanning is enabled using the TZ stage 660 which can move the wafer holder 620 in translational movements, rotational movements, and longitudinal movements. In some embodiments, the first scanner 670 and the second scanner 680 may be the same scanner coupled to both the light source 630 and the light detector 640. The light source 630 may be as described above for system 600a, and the light detector 640 may be as described above for system 600a.

Again, the relay optics 650 are positioned to collect, focus, and potentially filter the emitted light. And the relay optics 650 optimize the signal quality reaching the light detector 640. In various embodiments, an additional spatial filter may be added to control stray light, or potential ambient light.

The main difference between system 600b and the system 600a is the enablement of potential scanning embodiments in the system 600b. Specifically, the scanning may be enable by the first scanner 670, the second scanner 680, and/or the TZ stage 660.

The TZ stage 660 may be configured to perform movements of the bonded wafer 100 in X, Y, and Z linear directions, as well as perform rotations about a rotation direction, T. Specifically, the TZ stage 660 may be configured to perform vertical and rotational movements, such as moving the bonded wafer 100 up or down in the Z direction, and a linear stage of the TZ stage 660 may be configured to perform translational movements within the XY plane. Various conventional stages may be used for the TZ stage 660 where a stage controller (not shown) may control drivers of the stage to perform the scanning.

In the embodiment illustrated in FIG. 6B, the controller 690 is coupled to the wafer holder 620, the TZ stage 660, the first scanner 670, the second scanner 680, the light source 630, the light detector 640, and the second scanner 680. Additionally, in the system 600b, the controller 690 is coupled to the memory 695 storing instructions to be executed in the controller 690. The controller 690, and the memory 695 may be as described above.

The system 600b configuration, with its scanning capability, provides enhanced spatial resolution and flexibility in thermal analysis of bonded wafer structures. This setup allows for rapid, high-resolution mapping of thermal properties across the wafer surface, enabling detailed detection and characterization of defects such as voids or cracks in bonded interfaces. The integration of scanning capabilities with precise optical components and computerized control allows for advanced non-destructive evaluation techniques to be applied to bonded wafer structures. Additional example embodiment methods for identifying and detecting defects which may be implemented using either of the systems 600a-b of FIGS. 6A-6B are described using the flowcharts of FIGS. 7-8.

FIGS. 7-8 are flowcharts illustrating example methods of identifying and detecting defects in a bonded wafer in accordance with embodiments of the disclosure. The methods of FIGS. 7-8 may be combined with other methods and performed using the systems and apparatuses as described herein. For example, the methods of FIGS. 7-8 may be implemented in the system 600a of FIG. 6A or the system 600b of FIG. 6B. Although shown in a logical order, the arrangement and numbering of the steps of FIGS. 7-8 are not intended to be limiting.

Referring to FIG. 7, step 710 of a method 700 of identifying and detecting defects in a bonded wafer receives a bonded wafer on a wafer holder. In various embodiments, the bonded wafer comprises a first structure bonded to a second structure through a bonding layer comprising metal contacts. For example, the bonded wafer may be the bonded wafer 100. Other embodiments may use a sample comprising multiple layers of alternating dielectric, metal containing, or other types of conventional layers used in semiconductor fabrication, such as a photoresist layer, and comprising features formed between layers in the sample comprising different thermal conductivities. In some embodiments, the first structure may be the first structure 10 and the second structure may be the second structure 20.

After, the method 700 illuminates a portion of the first structure for a first time duration to heat the portion of the first structure to a starting temperature in step 720. In step 720, a light may be configured to heat the portion of the first structure according to a processing recipe in order to form a temperature differential between the portion of the first structure and the rest of the bonded wafer. And the first time duration may be configured such that the desired temperature is reached according to the power of the light emitted by the light source, and may be rapid such as a pulse. Additionally, the light used in the illuminating may be the illumination light described above for the methods described using FIGS. 1, 4, and 5. A light source may be used in the illumination and may be as described above for the light source 630, or the light sources described for FIGS. 1, 4, and 5. In some embodiments, the light source used in the illuminating may be a heat lamp. The light source may also be capable of providing excitation light for embodiments to enable bandgap photoluminescence techniques. The method may further comprise selecting either a blanket exposure of the entire bonded wafer (the portion of the first structure is the entire first structure), a substantial portion of the wafer, or a scanning exposure where the illuminating uses a light beam scanned across the bonded wafer.

Step 730 of the method 700 detects, using a light detector, a temperature map of the bonded wafer, the temperature map being detected after a second time duration. The light detector may be as described above for the light detector 640 of FIG. 6, the light detector 410 of FIG. 4, or the light detector 540 of FIG. 5. In some embodiments, the temperature map may be detected using the light detector where a light source emitted excitation light to enable the bandgap photoluminescence technique to measure photoluminescence photons of a particular layer of the bonded wafer. In other embodiments, a photodetector capable of detecting infrared light radiated from the bonded wafer may be used to determine the temperature map of the bonded wafer. And the method 700, in step 740, determines, based on the temperature map of the bonded wafer, a defect in the bonding layer of the bonded wafer.

In various embodiments, the method 700 in step 740 uses the temperature map to monitor for different thermal properties between regions of the bonded wafer than expected based on a design map of the bonded wafer. Regions comprising vastly different thermal conductivities (or temperatures) correspond to potential defects present in the bonding layer of the bonded wafer. For example, regions comprising metal contacts have higher thermal conductivities than regions only comprising dielectric layers. Consequently, a region comprising a metal contact according to the design map that exhibits thermal behavior inconsistent with a metal contact indicates the presence of either a void, or a potential crack in the imaged layer.

Other embodiments may use a plurality of temperature maps of the bonded wafer to determine defects. And in those embodiments, the defects may be detected using rates of temperature change of particular regions of the bonded wafer over time.

The method of 700 has the advantage of being a rapid, non-destructive method of determining the presence of potential defects in a bonded wafer. This method may enable higher resolution, location-specific, and non-destructive detection of defects. Additionally, in an embodiment, the light source may be used to specifically target a region found to contain a void, heat that particular region, and potentially anneal and ameliorate the defect in the bonded wafer. In some embodiments, the steps 720, 730, and 740 may be parts of a cyclic process to enable the scanning of the bonded wafer. Such embodiments may be implemented using the system 600b described using FIG. 6B above.

In various embodiments, the first time duration may be determined based on the intensity and wavelength of light used in the illuminating such that the portion of the first structure is heated to the starting temperature within the first time duration. The light may be configured with a particular wavelength and energy such that the penetration depth, and absorption depth of the light specifically heats a target layer (or portion) of the bonded wafer, such as the bonding layer, or the first structure, or a region directly above or below the bonding layer. Additionally, the light source may be capable of emitting a second light beam configured to cause the stimulated emission of photoluminescence photons through bandgap photoluminescence of the bonded wafer.

Now referring to FIG. 8, step 810 of a method 800 of identifying and detecting defects in a bonded wafer loads a substrate on a wafer holder of a chamber. The substrate comprises an interface layer, first contacts and second contacts, where the first contacts are aligned to physically contact the second contacts at the interface layer. The substrate may be the bonded wafer 100, and the wafer holder may be the wafer holder 620 in various embodiments. In an embodiment, the interface layer may be the bonding layer 113 of the bonded wafer 100. The chamber may be the chamber 610 of system 600b in FIG. 6B in an embodiment. After, in step 820, the method 800 heats a portion of the substrate.

Step 820 may perform the heating in a suitable method for raising the temperature of the portion of the substrate to a desired temperature. For example, the heating may be accomplished by illuminating the portion of the substrate using a heat lamp, or some form of localized light source in various embodiments. Other embodiments may heat the portion of the substrate using a temperature controller disposed within a wafer holder holding the substrate. As an example, localized heating may be accomplished by only heating a portion of the wafer holder, which subsequently only heats the portion of the substrate in physical contact. In step 830, the method 800 cools the substrate after the heating for a cooling period. In various embodiments, the cooling is performed by stopping the heating and letting the heated portion of the substrate distribute throughout the remaining portions of the substrate.

Step 840 of the method 800, during the cooling period, images the substrate to obtain a heat map of the substrate. The heat map of the substrate may include a heat map of all of the substrate or a region or a layer of the substrate in various embodiments. In various embodiments, the imaging may be performed using a light detector to collect light emitted from the substrate. In some embodiments, the light detector may be capable of collecting light from specific layers of the substrate, such as by using bandgap photoluminescence techniques. Further, the light detector may be an infrared camera configured to collect blackbody radiation from the substrate in an embodiment. Additionally, in various embodiments, the heat map may be as described for the temperature maps above.

Still referring to FIG. 8, step 850 of the method 800 determines a defect between the first and the second contacts in the interface layer of the substrate based on comparing the heat map with a design map of the substrate. This comparison may be as described for embodiments of the method 700 in step 740 above.

In some embodiments, the steps 820, 830, 840, and 850 may be parts of a cyclic process which enables the scanning of the substrate. Such embodiments may be implemented using the system 600b described using FIG. 6B.

Both methods 700-800 enable non-destructive identification and detection of defects in a bonded wafer or substrate. And either method may be implemented in the various systems and apparatuses described above. Further, the methods described throughout this disclosure may be used on any sample comprising multiple layers with features comprising different thermal conductivities in comparison to surrounding structures in the sample.

Example embodiments of the invention are described below. Other embodiments can also be understood from the entirety of the specification as well as the claims filed herein.

Example 1. A method for detecting a defect in a bonded wafer includes receiving the bonded wafer on a wafer holder, the bonded wafer including a first structure bonded to a second structure, the first structure including first contacts, the second structure including second contacts, and the first structure bonded to the second structure forming a bonding layer including metal contacts between the first contacts and the second contacts. The method further includes illuminating a portion of the first structure for a first time duration to heat the portion of the first structure to a starting temperature, and detecting, using a light detector, a temperature map of the bonded wafer, the temperature map being detected after a second time duration. And the method further includes determining, based on the temperature map, the defect in the bonding layer of the bonded wafer.

Example 2. The method of example 1, where the first structure includes a die and the second structure includes a wafer, or the first structure includes a first wafer and the second structure includes a second wafer.

Example 3. The method of one of examples 1 or 2, where the illuminating directs light having wavelengths between 700 nm and 1200 nm.

Example 4. The method of one of examples 1 to 3, where the portion of the first structure includes all of the first structure.

Example 5. The method of one of examples 1 to 4, where detecting the temperature map includes detecting infrared light radiated from the bonded wafer.

Example 6. The method of one of examples 1 to 5, where detecting the temperature map of the bonded wafer includes illuminating the bonded wafer to cause the bonded wafer to emit bandgap photoluminescence light, collecting the bandgap photoluminescence light using the light detector, and determining, based on the bandgap photoluminescence light, temperatures to construct the temperature map of the bonded wafer.

Example 7. The method of one of examples 1 to 6, where determining the defect in the bonding layer of the bonded wafer includes detecting variations between the temperature map and a design map of the bonded wafer including the first and the second contacts.

Example 8. The method of one of examples 1 to 7, where the defect includes a void, or a crack between the first structure and the second structure, or a shift between the first contacts and the second contacts due to overlay error.

Example 9. The method of one of examples 1 to 8, where the second time duration begins after the first time duration.

Example 10. The method of one of examples 1 to 9, further includes, during the second time duration, obtaining a plurality of temperature maps of the bonded wafer. The method further includes determining an evolution of temperature around the first and the second contacts based on the plurality of temperature maps. And the method further includes determining the defect in the bonding layer of the bonded wafer based on the evolution of temperature.

Example 11. The method of one of examples 1 to 10, where determining the defect in the bonding layer of the bonded wafer includes determining a thermal conductivity map of the bonded wafer based on the temperature map, obtaining a design map of the bonded wafer including the first and the second contacts, and determining the defect in the bonding layer of the bonded wafer based on comparing the design map with the thermal conductivity map.

Example 12. The method of one of examples 1 to 11, where the illuminating, detecting, and determining are part of a cyclic process, and the illuminating includes a scanning process.

Example 13. A method for detecting a defect in a substrate includes loading the substrate on a wafer holder of a chamber, the substrate including an interface layer, first contacts and second contacts, the first contacts aligned to physically contact the second contacts at the interface layer. The method further includes heating a portion of the substrate, cooling the substrate after the heating for a cooling period, and during the cooling period, imaging the substrate to obtain a heat map of the substrate. And the method further includes determining the defect between the first and the second contacts in the interface layer of the substrate based on comparing the heat map with a design map of the substrate.

Example 14. The method of example 13, where the heating includes illuminating the portion of the substrate using a light source, or increasing a temperature of a wafer holder contacting the substrate.

Example 15. The method of one of examples 13 or 14, where the portion of the substrate includes all of the substrate.

Example 16. The method of one of examples 13 to 15, where the substrate includes a bonded wafer, and the interface layer includes a bonding layer of the bonded wafer.

Example 17. The method of one of examples 13 to 16, where imaging the substrate to obtain the heat map of the substrate includes collecting infrared light radiated from the substrate.

Example 18. The method of one of examples 13 to 17, where imaging the substrate to obtain the heat map of the substrate includes illuminating the substrate to cause the substrate to emit bandgap photoluminescence light, collecting the bandgap photoluminescence light using a light detector, and determining, based on the bandgap photoluminescence light, temperatures to construct a heat map of the substrate.

Example 19. A system for detecting a defect in a bonded wafer includes a wafer holder disposed in a chamber, a light source and a light detector. And the system further includes a controller coupled to the wafer holder, the chamber, the light source, the light detector, and a memory storing instructions to be executed in the controller. The instructions when executed cause the controller to receive the bonded wafer on the wafer holder, the bonded wafer including a first structure bonded to a second structure, the first structure including first contacts, the second structure including second contacts, and the first structure bonded to the second structure forming a bonding layer including metal contacts between the first contacts and the second contacts. The instructions when executed further cause the controller to illuminate, using the light source, a portion of the first structure for a first time duration to heat the portion of the first structure to a starting temperature, and detect, using the light detector, a temperature map of the bonded wafer, the temperature map being detected after a second time duration. And the instructions when executed further cause the controller to determine, based on the temperature map, the defect in the bonding layer of the bonded wafer.

Example 20. The system of example 19, where the light source includes a laser diode, or a pulsed laser.

Example 21. The system of one of examples 19 or 20, further including a TZ stage coupled to the wafer holder to enable scanning of the bonded wafer.

Example 22. The system of one of examples 19 to 21, where the light detector includes an imaging microscope capable of flood illumination, and where the imaging microscope includes either a bandgap photoluminescence microscope or a mid-infrared (mid-IR) camera.

Example 23. The system of one of examples 19 to 22, where the light detector includes a line sensor, or a time delay integration (TDI) sensor, or a spot-scanning system, or an infrared camera.

Example 24. The system of one of examples 19 to 23, further including relay optics disposed between the bonded wafer and the light detector to route emitted light from the bonded wafer to the light detector, and where the relay optics include a spatial filter configured to select a measurement depth and a measurement layer thickness of the bonded wafer.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for detecting a defect in a bonded wafer, the method comprising:
receiving the bonded wafer on a wafer holder, the bonded wafer comprising a first structure bonded to a second structure, the first structure comprising first contacts, the second structure comprising second contacts, and the first structure bonded to the second structure forming a bonding layer comprising metal contacts between the first contacts and the second contacts;
illuminating a portion of the first structure for a first time duration to heat the portion of the first structure to a starting temperature;
detecting, using a light detector, a temperature map of the bonded wafer, the temperature map being detected after a second time duration; and
determining, based on the temperature map, the defect in the bonding layer of the bonded wafer.

2. The method of claim 1, wherein the first structure comprises a die and the second structure comprises a wafer, or the first structure comprises a first wafer and the second structure comprises a second wafer.

3. The method of claim 1, wherein the portion of the first structure comprises all of the first structure.

4. The method of claim 1, wherein detecting the temperature map comprises detecting infrared light radiated from the bonded wafer.

5. The method of claim 1, wherein detecting the temperature map of the bonded wafer comprises:
illuminating the bonded wafer to cause the bonded wafer to emit bandgap photoluminescence light;
collecting the bandgap photoluminescence light using the light detector; and
determining, based on the bandgap photoluminescence light, temperatures to construct the temperature map of the bonded wafer.

6. The method of claim 1, wherein determining the defect in the bonding layer of the bonded wafer comprises detecting variations between the temperature map and a design map of the bonded wafer comprising the first and the second contacts.

7. The method of claim 1, wherein the defect comprises a void, or a crack between the first structure and the second structure, or a shift between the first contacts and the second contacts due to overlay error.

8. The method of claim 1, further comprising:
during the second time duration, obtaining a plurality of temperature maps of the bonded wafer;
determining an evolution of temperature around the first and the second contacts based on the plurality of temperature maps; and
determining the defect in the bonding layer of the bonded wafer based on the evolution of temperature.

9. The method of claim 1, wherein determining the defect in the bonding layer of the bonded wafer comprises:
determining a thermal conductivity map of the bonded wafer based on the temperature map;
obtaining a design map of the bonded wafer comprising the first and the second contacts; and
determining the defect in the bonding layer of the bonded wafer based on comparing the design map with the thermal conductivity map.

10. The method of claim 1, wherein the illuminating, detecting, and determining are part of a cyclic process, and the illuminating comprises a scanning process.

11. A method for detecting a defect in a substrate, the method comprising:
loading the substrate on a wafer holder of a chamber, the substrate comprising an interface layer, first contacts and second contacts, the first contacts aligned to physically contact the second contacts at the interface layer;
heating a portion of the substrate;
cooling the substrate after the heating for a cooling period;
during the cooling period, imaging the substrate to obtain a heat map of the substrate; and
determining the defect between the first and the second contacts in the interface layer of the substrate based on comparing the heat map with a design map of the substrate.

12. The method of claim 11, wherein the heating comprises illuminating the portion of the substrate using a light source, or increasing a temperature of a wafer holder contacting the substrate.

13. The method of claim 11, wherein imaging the substrate to obtain the heat map of the substrate comprises collecting infrared light radiated from the substrate.

14. The method of claim 11, wherein imaging the substrate to obtain the heat map of the substrate comprises:
illuminating the substrate to cause the substrate to emit bandgap photoluminescence light;
collecting the bandgap photoluminescence light using a light detector; and
determining, based on the bandgap photoluminescence light, temperatures to construct a heat map of the substrate.

15. A system for detecting a defect in a bonded wafer, the system comprising:
a wafer holder disposed in a chamber;
a light source and a light detector; and
a controller coupled to the wafer holder, the chamber, the light source, the light detector, and a memory storing instructions to be executed in the controller, the instructions when executed cause the controller to:
receive the bonded wafer on the wafer holder, the bonded wafer comprising a first structure bonded to a second structure, the first structure comprising first contacts, the second structure comprising second contacts, and the first structure bonded to the second structure forming a bonding layer comprising metal contacts between the first contacts and the second contacts;
illuminate, using the light source, a portion of the first structure for a first time duration to heat the portion of the first structure to a starting temperature;
detect, using the light detector, a temperature map of the bonded wafer, the temperature map being detected after a second time duration; and
determine, based on the temperature map, the defect in the bonding layer of the bonded wafer.

16. The system of claim 15, wherein the light source comprises a laser diode, or a pulsed laser.

17. The system of claim 15, further comprising a TZ stage coupled to the wafer holder to enable scanning of the bonded wafer.

18. The system of claim 15, wherein the light detector comprises an imaging microscope capable of flood illumination, and wherein the imaging microscope comprises either a bandgap photoluminescence microscope or a mid-infrared (mid-IR) camera.

19. The system of claim 15, wherein the light detector comprises a line sensor, or a time delay integration (TDI) sensor, or a spot-scanning system, or an infrared camera.

20. The system of claim 15, further comprising relay optics disposed between the bonded wafer and the light detector to route emitted light from the bonded wafer to the light detector, and wherein the relay optics comprise a spatial filter configured to select a measurement depth and a measurement layer thickness of the bonded wafer.
